(19) United States
(12) Patent Application Publication
(10) Pub. No.: US 2023/0258781 A1
(43) Pub. Date: Aug. 17, 2023

(54) LIDAR SYSTEM FOR CAPTURING DIFFERENT FIELD-OF-VIEWS WITH DIFFERENT RESOLUTIONS

(71) Applicant: BEIJING VOYAGER TECHNOLOGY CO., LTD., Beijing (CN)

(72) Inventors: Yonghong GUO, Mountain View, CA (US); Youmin WANG, Berkeley, CA (US); Yue LU, Los Gatos, CA (US)

(73) Assignee: BEIJING VOYAGER TECHNOLOGY CO., LTD., Beijing (CN)

(21) Appl. No.: 17/673,701

(22) Filed: Feb. 16, 2022

(51) Int. Cl. G01S 7/484; G01S 7/481; G01S 17/931; G01S 7/4863

(52) U.S. Cl. CPC G01S 7/484; G01S 7/4817; G01S 17/931; G01S 7/4863

(57) ABSTRACT

Embodiments of the disclosure provide for a LiDAR system. The LiDAR system may generate a first FOV that is large and has rough resolution and a second FOV that is smaller and has a finer resolution. For an area of importance, such as along the horizon where pedestrians, vehicles, or other objects may be located, the second FOV with the finer resolution may be used. Using fine resolution for the area of importance may achieve a higher-degree of accuracy/safety in terms of autonomous navigation decision-making than if coarse resolution is used. Because the use of fine resolution is limited to a relatively small area, a reasonably sized photodetector and laser power may still be used to generate a long distance, high-resolution point-cloud.

### TECHNICAL FIELD

The present disclosure relates to a Light Detection and Ranging (LiDAR) system, and more particularly to, a LiDAR system with integrated scanners configured to capture a large field-of-view (FOV) with low-resolution and a small FOV with high-resolution.

### BACKGROUND

Optical sensing systems, e.g., such as LiDAR systems, have been widely used in advanced navigation technologies, such as to aid autonomous driving or to generate high-definition maps. For example, a typical LiDAR system measures the distance to a target by illuminating the target with pulsed laser light beams that are steered towards an object in the far field using a scanning mirror, and then measuring the reflected pulses with a sensor. Differences in laser light return times, wavelengths, and/or phases (also referred to as “time-of-flight (ToF) measurements”) can then be used to construct digital three-dimensional (3D) representations of the target. Because using a narrow laser beam as the incident light can map physical features with a high-degree of accuracy, a LiDAR system is particularly suitable for applications such as sensing in autonomous driving and high-definition map surveys.

To scan the narrow laser beam across a broad field-of-view (FOV) in two-dimensions (2D), conventional systems generally use one of a flash or scanning LiDAR. In flash LiDAR, the entire FOV is illuminated with a wide, diverging laser beam in a single pulse. This is in contrast to scanning LiDAR, which uses a collimated laser beam that illuminates one point at a time, and the beam is raster scanned to illuminate the FOV point-by-point.

Using conventional systems to construct a point-cloud with a large FOV, a high-resolution, and from a long distance presents various challenges, however. For example, a 120° (horizontal)×30° (vertical) FOV point-cloud with a resolution of 0.01° would have thirty-six million points. It may be difficult or impossible to achieve a point cloud of this size and resolution using existing flash or scanning LiDAR systems. This is because the detector array of existing flash LiDAR systems lacks the requisite number of pixels, and conventional scanning LiDAR systems are unable to scan this many points within a short (e.g., the 100 milliseconds (ms)) scanning period for an entire FOV.

Another challenge in constructing the above-mentioned point-cloud relates to the requisite laser power. The amount of laser power received by a single pixel decreases as the number of pixels in a detector increases. Thus, to increase a point-cloud resolution from 0.1° to 0.01°, the number of pixels in the photodetector array would need to be increased by a factor of one-hundred, while the amount of laser power received by a single pixel would be decreased by a factor of one-hundred. A reduced laser power per pixel significantly impacts the detection accuracy due to, e.g., a lower signal-to-noise (SNR) ratio. Moreover, the detection range of a LiDAR system decreases as resolution increases. For example, a system with a resolution ten-times higher has a detection range ten-times shorter, assuming the same laser power.

Thus, there exists an unmet need for a LiDAR system that can cover a larger FOV at a lower resolution and a smaller FOV at a higher resolution, as compared with conventional systems.

### SUMMARY

Embodiments of the disclosure provide for a LiDAR system. The LiDAR system may include a first transmitter subsystem and a second transmitter subsystem. The first transmitter subsystem may include a first light source configured to emit first light beams during a first optical sensing procedure associated with a first FOV and a first resolution. The second transmitter subsystem may include a second light source configured to emit second light beams during a second optical sensing procedure associated with a second FOV and a second resolution finer than the first resolution. The LiDAR system may include at least one photodetector configured to detect light returned from the first FOV during the first optical sensing procedure and from the second FOV during the second optical sensing procedure. The LiDAR system may include a signal processor coupled to the at least one photodetector. The signal processor may be configured to generate a first point cloud of the first FOV with the first resolution based on the light returned from the first FOV during the first optical sensing procedure. The signal processor may be configured to generate a second point cloud of the second FOV with the second resolution based on the light returned from the second FOV during the second optical sensing procedure.

Embodiments of the disclosure also provide for a transmitter for a light detection and ranging (LiDAR) system. The transmitter may include a first transmitter subsystem and a second transmitter subsystem. The first transmitter subsystem may include a first light source configured to emit first light beams during a first optical sensing procedure associated with a first field-of-view (FOV) and a first resolution. The second transmitter subsystem may include a second light source configured to emit second light beams during a second optical sensing procedure associated with a second FOV and a second resolution finer than the first resolution.

Embodiments of the disclosure further provide for a method for operating a LiDAR system. The method may include emitting, by a first light source of a first transmitter subsystem, first light beams during a first optical sensing procedure associated with a first field-of-view (FOV) and a first resolution. The method may include emitting, by a second light source of a second transmitter subsystem, second light beams during a second optical sensing procedure associated with a second FOV and a second resolution finer than the first resolution. The method may include detecting, by at least one photodetector, light returned from the first FOV during the first optical sensing procedure and from the second FOV during the second optical sensing procedure. The method may include generating, by a signal processor, a first point cloud of the first FOV with the first resolution based on the light returned from the first FOV during the first optical sensing procedure. The method may include generating, by the signal processor, a second point cloud of the second FOV with the second resolution based on the light returned from the second FOV during the second optical sensing procedure.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a block diagram of an exemplary LiDAR system, according to embodiments of the disclosure.

FIG. 2A illustrates a first exemplary scanning pattern performed using one-dimensional (1D) flash, a 1D horizontal scanner, and a 1D photodetector array to capture a large FOV with rough resolution, according to embodiments of the disclosure.

FIG. 2B illustrates a second exemplary scanning pattern performed using a 1D vertical microelectricalmechanical system (MEMS) scanner, a 1D horizontal scanner, and a single photodetector to capture a large FOV with rough resolution, according to embodiments of the disclosure.

FIG. 2C illustrates a third exemplary scanning pattern performed using a 1D vertical MEMS scanner, a 1D horizontal scanner, and a 1D photodetector array to capture a large FOV with rough resolution, according to embodiments of the disclosure.

FIG. 3A illustrates a fourth exemplary scanning pattern performed using a two-dimensional (2D) flash, a 1D horizontal scanner, and a 2D photodetector array to capture a small FOV with fine resolution, according to embodiments of the disclosure.

FIG. 3B illustrates a fifth exemplary scanning pattern performed using 1D vertical MEMS scanner, a 1D horizontal scanner, and a 1D photodetector array to capture a small FOV with fine resolution, according to some embodiments of the disclosure.

FIG. 3C illustrates a sixth exemplary scanning pattern performed using a 2D MEMS scanner and a single photodetector to capture a small FOV with fine resolution, according to some embodiments of the disclosure.

FIG. 4 illustrates a flow chart of an exemplary method for operating a LiDAR system, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

LiDAR is an optical sensing technology that enables autonomous vehicles to “see” the surrounding world, creating a virtual model of the environment to facilitate decision-making and navigation. An optical sensor (e.g., LiDAR transmitter and receiver) creates a 3D map of the surrounding environment using laser beams and time-of-flight (ToF) distance measurements. ToF, which is one of LiDAR's operational principles, provides distance information by measuring the travel time of a collimated laser beam to reflect off an object and return to the sensor. Reflected light signals are measured and processed at the vehicle to detect, identify, and decide how to interact with or avoid objects.

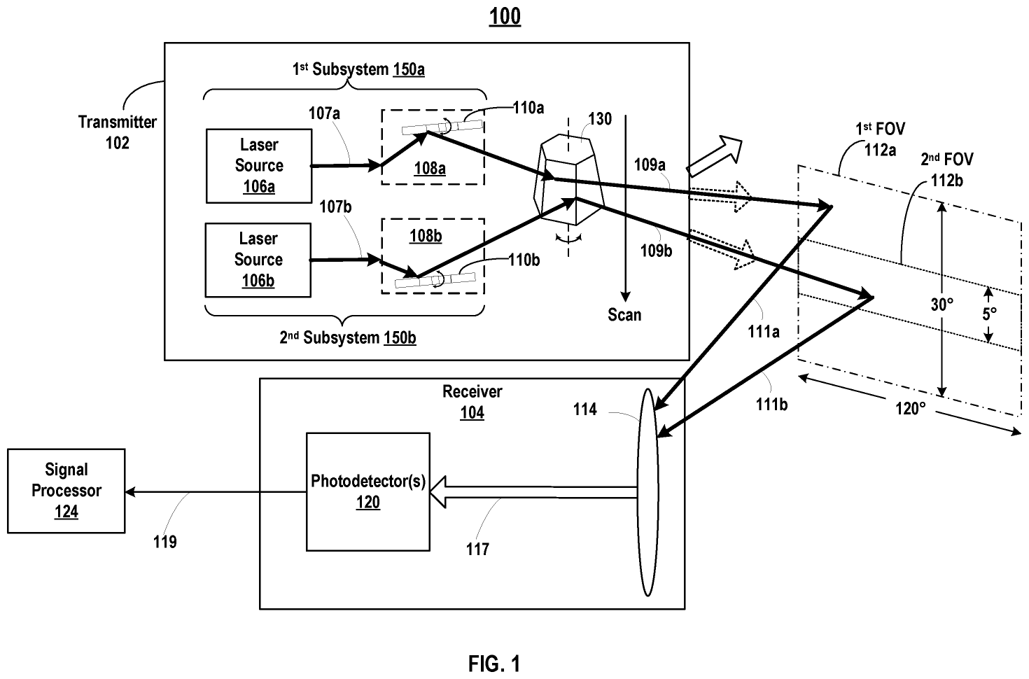

Due to the challenges imposed by existing LiDAR systems as discussed above in the BACKGROUND section, the present disclosure provides an exemplary LiDAR system that captures two FOVs of different sizes at different resolutions. The first FOV may be large in size and captured with a rough resolution, while the second FOV may be comparatively smaller and captured with a finer resolution. For an area of importance, such as along the horizon where pedestrians, vehicles, or other objects may be located/moving, the second FOV with finer resolution may be used. Using fine resolution for the area of importance may achieve a higher-degree of accuracy in terms of object identification, and therefore, provide a higher-degree of safety in terms of autonomous navigation decision-making. For the region(s) other than the second FOV, e.g., such as the peripheral regions away from the horizon, the first FOV with the rough resolution may be used. Because the use of fine resolution scanning/detecting is limited to a relatively small area, a photodetector of reasonable size and a laser beam of reasonable power may still be used to generate a long distance, high-resolution point-cloud for the second FOV. Additional details of the exemplary LiDAR system are provided below in connection with FIGS. 1-4.

Some exemplary embodiments are described below with reference to a receiver used in LiDAR system(s), but the application of the emitter array disclosed by the present disclosure is not limited to the LiDAR system. Rather, one of ordinary skill would understand that the following description, embodiments, and techniques may apply to any type of optical sensing system (e.g., biomedical imaging, 3D scanning, tracking and targeting, free-space optical communications (FSOC), and telecommunications, just to name a few) known in the art without departing from the scope of the present disclosure.

FIG. 1 illustrates a block diagram of an exemplary LiDAR system 100, according to embodiments of the disclosure. LiDAR system 100 may include a transmitter 102 and a receiver 104. Transmitter 102 may emit laser beams along multiple directions using different transmitter subsystems for different FOVs. For example, transmitter 102 may include a first transmitter subsystem 150a used to scan first FOV 112a with a first resolution (e.g., low-resolution) and a second transmitter subsystem 150 used to scan second FOV 112b with a second resolution (e.g., high-resolution). Second FOV 112b may include an area of importance, e.g., such as along the horizon where pedestrians, vehicles, or other objects may be located/moving. As mentioned above, using fine resolution for the area of importance may achieve a higher-degree of accuracy in terms of object identification, and therefore, provide a higher-degree of safety in terms of autonomous navigation decision-making.

When implemented using scanning LiDAR, transmitter 102 can sequentially emit a stream of pulsed laser beams in different directions within a scan range (e.g., a range of scanning angles in angular degrees), as illustrated in FIG. 1. First laser source 106a may be configured to emit a first laser beam 107a (also referred to as “native laser beam”) to first scanner 108a, while second laser source 106b may be configured to emit a second laser beam 107b to second scanner 108b. First laser source 106a and first scanner 108a may make up a first transmitter subsystem 150a. Second laser source 106b and second scanner 108 may make up a second transmitter subsystem 150b. In some embodiments, first laser source 106a and second laser source 106b may each generate a pulsed laser beam in the UV, visible, or near infrared wavelength range. First laser beam 107a may diverge in the space between first laser source 106a and first scanner 108a. Similarly, second laser beam 107b may diverge in the space between second laser source 106b and second scanner 108b. Thus, although not illustrated, transmitter 102 may further include a first collimating lens located between first laser source 106a and first scanner 108a and a second collimating lens located between second laser source 106b and second scanner 108b. Each of the collimating lenses may be configured to collimate divergent first laser beam 107a and divergent second laser beam 107b before they impinge on first scanner 108a and second scanner 108b, respectively. Although the transmitter subsystems in FIG. 1 are depicted as including scanners, the implementation of the transmitter subsystems is not limited thereto. Instead, one or more of first transmitter subsystem 150a and/or second transmitter subsystem 150b may be implemented using flash LiDAR technology. When flash LiDAR technology is used, the collimating lens may be omitted since its divergent laser beam (e.g., which has a vertical width that covers the vertical width of the FOV) is scanned across different horizontal angles.

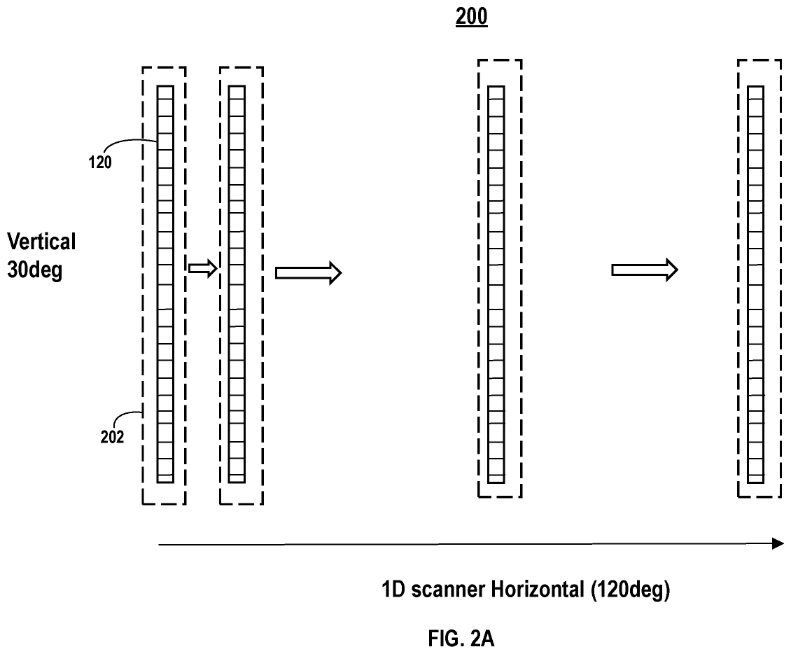

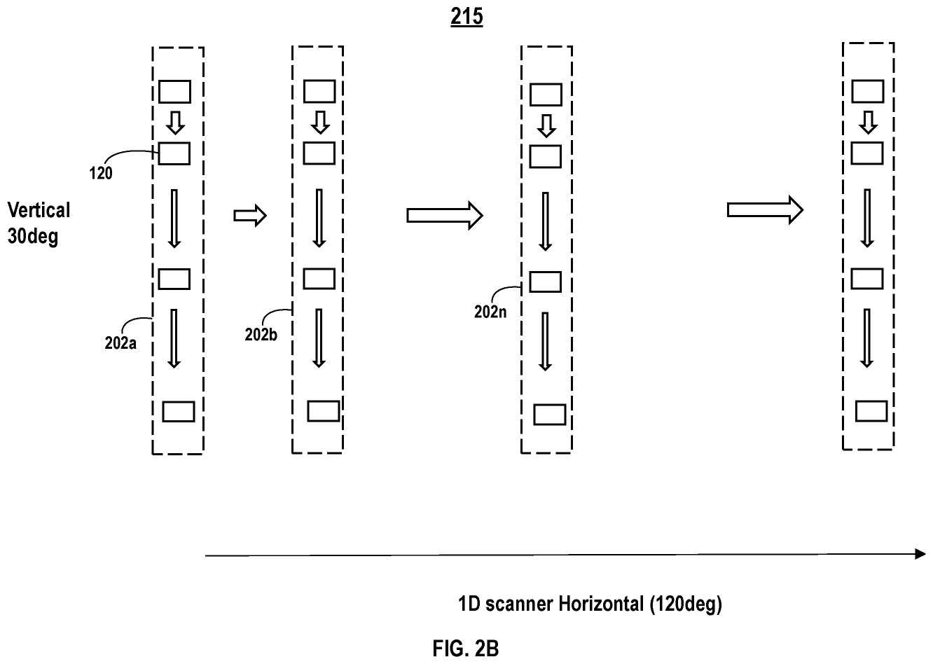

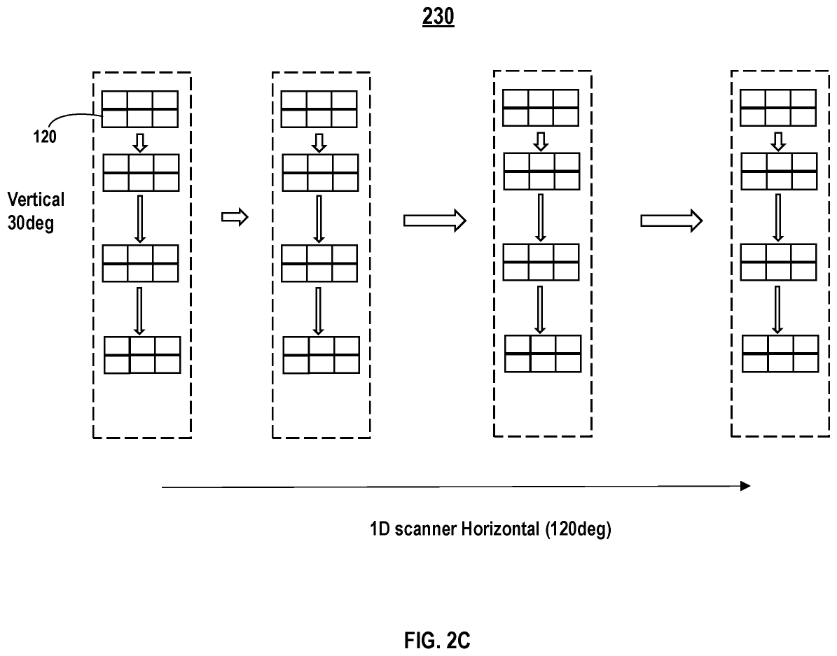

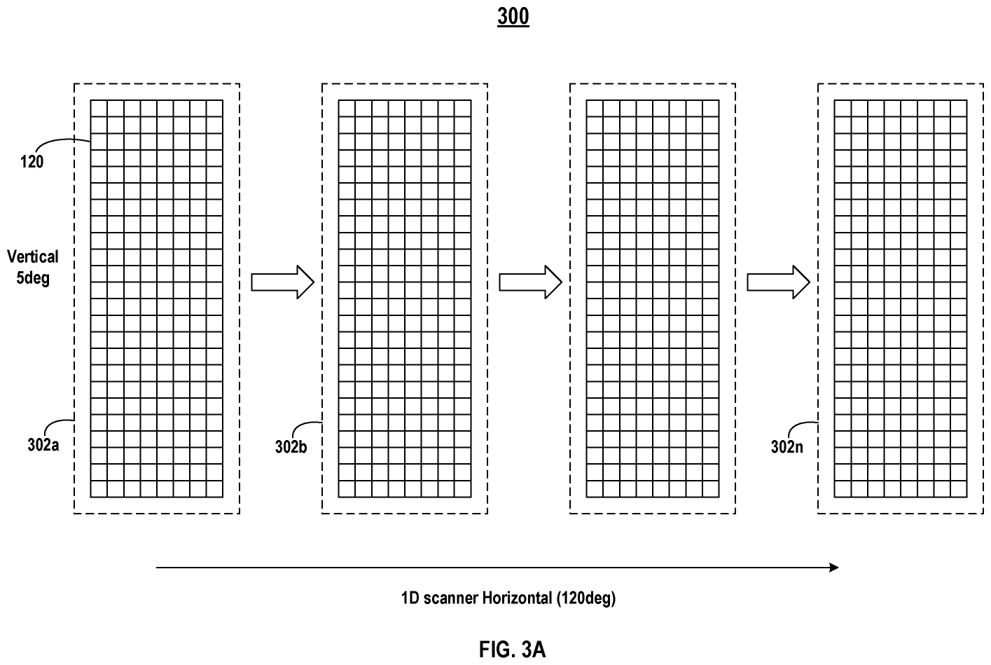

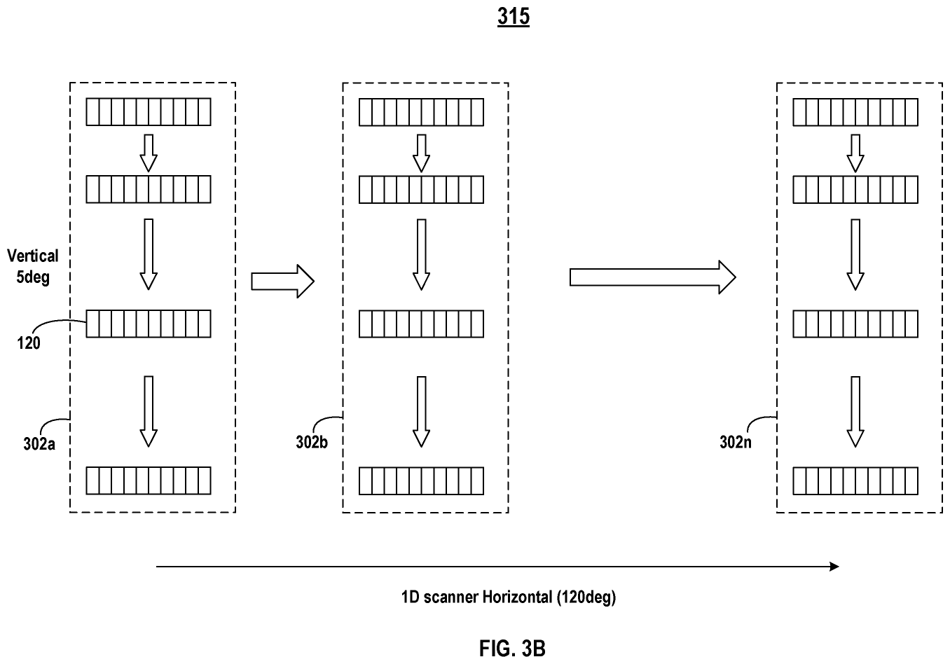

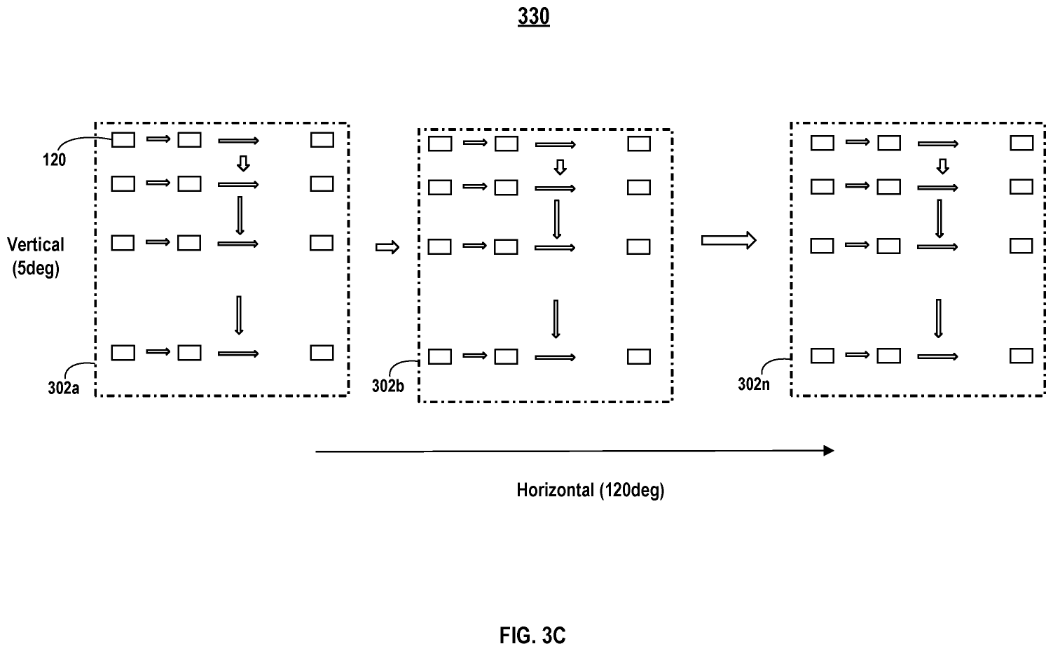

Furthermore, the transmitter subsystem may not include a scanner when flash LiDAR is used. For example, when first transmitter subsystem 150a is configured to perform the first exemplary scanning pattern 200 depicted in FIG. 2A, first scanner 108a and the collimating lens may be omitted. Here, the vertical width of first laser beam 107a may span the vertical width of first FOV 112a and only a portion of the horizontal width of first FOV 112a. Thus, during each cycle of a first scanning procedure used to scan first FOV 112a, the mechanical scanner (e.g., polygon scanner 130 in FIG. 1) may steer the vertical line (e.g., third laser beam 109a) to a different horizontal position until first FOV 112a has been scanned in its entirety. Similarly, when second transmitter subsystem 150b is configured to perform the fourth exemplary scanning pattern 300 depicted in FIG. 3A, second scanner 108b and collimating lens may be omitted. Here, the vertical width of second laser beam 107b may span the vertical width of second FOV 112b and a portion of the horizontal width of second FOV 112b. Thus, during each cycle of a second scanning procedure used to scan second FOV 112b, the mechanical scanner (e.g., polygon scanner 130 in FIG. 1) may steer the vertical line (e.g., fourth laser beam 109b) to a different horizontal position until second FOV 112a has been scanned in its entirety. First transmitter subsystem 150a may be configured to perform any one of the exemplary scanning patterns 200, 215, 230 depicted in FIGS. 2A-2C. Second transmitter subsystem 150b may be configured to perform any one of the exemplary scanning patterns 300, 315, 330 depicted in FIGS. 3A-3C.

In some embodiments of the present disclosure, first laser source 106a and second laser source 106b may include a pulsed laser diode (PLD), a vertical-cavity surface-emitting laser (VCSEL), a fiber laser, etc. For example, a PLD may be a semiconductor device similar to a light-emitting diode (LED) in which the laser beam is created at the diode's junction. In some embodiments of the present disclosure, a PLD includes a PIN diode in which the active region is in the intrinsic (I) region, and the carriers (electrons and holes) are pumped into the active region from the N and P regions, respectively. Depending on the semiconductor materials, the wavelength of incident laser beam 107 provided by a PLD may be greater than 700 nm, such as 760 nm, 785 nm, 808 nm, 848 nm, 905 nm, 940 nm, 980 nm, 1064 nm, 1083 nm, 1310 nm, 1370 nm, 1480 nm, 1512 nm, 1550 nm, 1625 nm, 1654 nm, 1877 nm, 1940 nm, 2000 nm, etc. It is understood that any suitable laser source may be used as first laser source 106a for emitting first laser beam 107a and second laser source 106b for emitting second laser beam 107b.

When first transmitter subsystem 150a is implemented using scanning LiDAR technology, first scanner 108a may be configured to steer a third laser beam 109a towards an object (e.g., stationary objects, moving objects, people, animals, trees, fallen branches, debris, metallic objects, non-metallic objects, rocks, rain, chemical compounds, aerosols, clouds and even single molecules, just to name a few) in a direction within a range of scanning angles of first FOV 112a. Similarly, when second transmitter subsystem 150b is implemented using scanning LiDAR technology, second scanner 108b may be configured to steer a fourth laser beam 109b towards an object in a direction within a range of scanning angles associated with second FOV 112b. First FOV 112a may have a vertical width in the range of 10° to 45°, a horizontal width in the range of 30° to 360°, and the resolution associated with first FOV 112a may be in the range of 0.05° to 0.5°. Second FOV 112b may have a vertical width in the range of 2° to 10°, a horizontal width in the range of 30° to 360°, and the resolution associated with second FOV 112b may be in the range of 0.005° to 0.1°, for instance. The vertical and horizontal widths and the resolutions described above for first FOV 112a and second FOV 112b are provided by way of example and not limitation. It is understood that other vertical and horizontal widths and resolutions may be used without departing from the scope of the present disclosure.

In some embodiments consistent with the present disclosure, first scanner 108a and second scanner 108b may include a micromachined mirror assembly, e.g., such as first scanning mirror 110a and second scanning mirror 110b. First scanning mirror 110a and second scanning mirror 110b may each be a microelectricalmechanical (MEMS) mirror. In some embodiments, first scanning mirror 110a and/or second scanning mirror 110b may be configured to resonate during the scanning procedure. Although not shown in FIG. 1, the planar mirror assemblies of first scanner 108a and second scanner 108b may also include various other elements. For example, these other elements may include, without limitation, a MEMS actuator, actuator anchor(s), a plurality of interconnects, scanning mirror anchor(s), just to name a few.

In some embodiments consistent with the present disclosure, transmitter 102 may include a mechanical scanner configured to steer third laser beam 109a in a horizontal scanning direction associated with first FOV 112a and fourth laser beam 109b in a horizontal scanning direction associated with second FOV 112b. In some embodiments, the mechanical scanner may include a polygon mirror assembly that includes polygon scanner 130. Although not shown in FIG. 1, polygon scanning assembly may include a driver mechanism configured to rotate polygon scanner 130 about its longitudinal axis during the scanning procedure. However, the mechanical scanner is not limited to a polygon scanning assembly. Instead, the mechanical scanner may include any type of mechanical scanning assembly known in the art without departing from the scope of the present disclosure. For example, a galvanometer may be used instead of a polygon scanning assembly. The mechanical scanner may be shared by first transmitter subsystem 150a and second transmitter subsystem 150b. Thus, the mechanical scanner may be considered part of each of the transmitter subsystems 150a, 150b. However, in some embodiments, e.g., such as when one of the transmitter subsystems includes a 2D MEMS scanner, the mechanical scanner may not be used by that transmitter subsystem and not considered a part thereof.

In some embodiments, receiver 104 may be configured to detect a first returned laser beam 111a returned from first FOV 112a and a second returned laser beam 111b returned from second FOV 112b. First returned laser beam 111a may be returned from an object located in first FOV 112a and have the same wavelength as third laser beam 109a. Second returned laser beam 111b may be returned from an object located in second FOV 112b and have the same wavelength as fourth laser beam 109b. First returned laser beam 111a may be in a different direction from third laser beam 109a, and second returned laser beam 11b may be in a different direction from fourth laser beam 109b. Third laser beam 109a and fourth laser beam 109b can be reflected by one or more objects in their respective FOVs via backscattering, e.g., such as Raman scattering and/or fluorescence.

As illustrated in FIG. 1, receiver 104 may collect the returned laser beams and output electrical signals proportional to their intensities. During a first optical sensing procedure, first returned laser beam 111a may be collected by lens 114 as laser beam 117. Similarly, during a second optical sensing procedure, second returned laser beam 111b may be collected by lens 114 as a different laser beam 117. The first optical sensing procedure and the second optical sensing procedure may be performed in a synchronized and/or coordinated fashion so that they do not interfere with each other. In other words, first returned laser beam 111a and second returned laser beam 111b are received by lens 114 at different times such that laser beam 117 does not include a mix of returned laser beams from the different FOVs. For example, a first portion of first FOV 112a may be scanned at t₀, a first portion of second FOV 112b may be scanned at t₁, a second portion of first FOV 112a may be scanned at t₂, a second portion of second FOV 112b may be scanned at t₃, and so on. In this example, t₀, t₁, t₂, and t₃ may be contiguous or non-contiguous in the time domain, depending on the implementation. Photodetector(s) 120 may convert the laser beam 117 collected by lens 114 into an electrical signal 119 (e.g., a current or a voltage signal).

In some embodiments, photodetector(s) 120 may include a single photodetector or photodetector array used for receiving laser beams returned from first FOV 112a and second FOV 112b. In some other embodiments, photodetector(s) 120 may include a first photodetector used for receiving laser beams returned from first FOV 112a and a second photodetector used for receiving laser beams returned from second FOV 112b. The type(s) of photodetector(s) 120 included in LiDAR system 100 may depend on the implementation of first transmitter subsystem 150a and second transmitter subsystem 150b. For instance, when first transmitter subsystem 150a includes 1D vertical flash and a 1D horizontal scanner, photodetector(s) 120 may include a 1D vertical line with pixelization (see FIG. 2A). In another example, when first transmitter subsystem 150a includes a 1D MEMS scanner (e.g., vertical scanner) and 1D mechanical scanner (e.g., horizontal scanner), photodetector(s) 120 may be implemented as a single photodetector without sub-pixelization (see FIG. 2B) or a single photodetector with sub-pixelization (see FIG. 2C). When second transmitter subsystem 150b includes a 2D vertical flash and 1D horizontal scanner, photodetector(s) 120 may be implemented as a 2D photodetector array (see FIG. 3A). Still further, when second transmitter subsystem 150b is implemented using a 1D vertical MEMS scanner and a 1D horizontal scanner, photodetector(s) 120 may be implemented as a 1D horizontal line with pixelization (see FIG. 3B). In yet another example, when second transmitter subsystem 150b includes a 2D MEMS scanner, photodetector(s) 120 may be implemented as a single photodetector with or without sub-pixelization (see FIG. 3C).

Regardless of the type of photodetector, an electrical signal 119 may be generated when photons are absorbed in a photodiode included in photodetector(s) 120. In some embodiments of the present disclosure, photodetector(s) 120 may include a PIN detector, a PIN detector array, an avalanche photodiode (APD) detector, a APD detector array, a single photon avalanche diode (SPAD) detector, a SPAD detector array, a silicon photo multiplier (SiPM/MPCC) detector, a SiP/MPCC detector array, or the like.

LiDAR system 100 may also include one or more signal processor 124. Signal processor 124 may receive electrical signal 119 generated by photodetector(s) 120. Signal processor 124 may process electrical signal 119 to determine, for example, distance information carried by electrical signal 119. Signal processor 124 may construct a first point cloud based on the processed information associated with first FOV 112a/first returned laser beam 111a and a second point cloud based on the processed information associated with second FOV 112b/second returned laser beam 111b. The first point cloud may include a first frame, which is an image of the far-field located in first FOV 112a at a particular point in time. The second point cloud may include a second frame, which is an image of the far-field located in second FOV 112b at a particular point in time. In this context, a frame is the data/image captured of the far-field environment within the 2D FOV (horizontal FOV and vertical FOV). Signal processor 124 may include a microprocessor, a microcontroller, a central processing unit (CPU), a graphical processing unit (GPU), a digital signal processor (DSP), or other suitable data processing devices.

Moreover, the present disclosure provides various combinations of transmitter subsystem types and photodetector types that achieve long-range, high-resolution imaging of second FOV 112b without the need for photodetector(s) 120 to be made up of an undue number of pixels. Additional details of these combinations are described below in connection with FIGS. 2A-2C and 3A-3C.

FIG. 2A illustrates a first exemplary scanning pattern 200 performed using a 1D vertical flash, a 1D horizontal scanner, and a 1D detector array to capture first FOV 112a of FIG. 1 with rough resolution, according to embodiments of the disclosure. FIG. 2B illustrates a second exemplary scanning pattern 215 performed using a 1D vertical MEMS scanner, a 1D horizontal scanner, and a single detector to capture first FOV 112a of FIG. 1 with rough resolution, according to embodiments of the disclosure. FIG. 2C illustrates a third exemplary scanning pattern 230 performed using a 1D vertical MEMS scanner, a 1D horizontal scanner, and a 1D detector array to capture first FOV 112a with rough resolution, according to embodiments of the disclosure. FIG. 3A illustrates a fourth exemplary scanning pattern 300 performed using 2D vertical flash, a 1D horizontal scanner, and a 2D photodetector array to capture second FOV 112b with fine resolution, according to embodiments of the disclosure. FIG. 3B illustrates a fifth exemplary scanning pattern 315 performed using 1D vertical MEMS scanner, a 1D horizontal scanner, and a 1D photodetector array to capture second FOV 112b of FIG. 1 with fine resolution, according to some embodiments of the disclosure. FIG. 3C illustrates a sixth exemplary scanning pattern performed using a 2D MEMS scanner and a single photodetector to capture second FOV 112b of FIG. 1 with fine resolution, according to some embodiments of the disclosure. FIGS. 2A-2C and 3A-3C will be described together with reference to FIG. 1.

Referring to FIGS. 1 and 2A, first FOV 112a may be scanned using a 1D vertical flash and a 1D horizontal scanner. In this embodiment, first laser source 106a may emit first laser beam 107a as a flash. Rather than emitting a point of light, first laser beam 107a may have a vertical width that spans the vertical width of first FOV 112a. When 1D vertical flash is used, first transmitter subsystem 150a may not include first scanner 108a or first scanning mirror 110a in FIG. 1. During a first optical sensing procedure, first laser source 106a may emit a single flash pulse during each cycle to scan first FOV 112a. Then, the mechanical scanner (e.g., polygon scanner 130, galvanometer, etc.) steers the flash pulse so that it illuminates a different horizontal slice 202 until first FOV 112a is fully scanned. Moreover, in this example, photodetector array(s) 120 may be a 1D detector array (e.g., a column of 300 pixels) that forms a single line that has the same or smaller dimensions as returned laser beam 111a.

Referring to FIGS. 1, 2B, and 2C, first FOV 112a may be scanned using 1D vertical MEMS scanner and a 1D horizontal scanner, in another embodiment consistent with the disclosure. Here, first laser source 106a may emit first laser beam 107a as a beam spot rather than a flash. In this example, first transmitter subsystem 150a may include first scanner 108a with a 1D MEMS scanning mirror (e.g., first scanning mirror 110a) that steers the beam spot to different vertical positions. In other words, the 1D MEMS scanning mirror may steer third laser beam 109a in a zig-zag pattern that moves down the vertical length of a first horizontal slice 202a each cycle until its vertical width has been scanned. Then, the 1D horizontal scanner (e.g., mechanical scanner) steers the laser beam to the second horizontal slice. The 1D MEMS scanning mirror steers third laser beam 109a back to the top of the second horizontal slice 202b before scanning down its vertical width. This scanning procedure is performed until the entire frame of first FOV 112a (e.g., which is the sum of all horizontal slices 202a, 202b . . . 202n) is scanned. Each horizontal slice is associated with one cycle of the scanning procedure for a frame.

When LiDAR system 100 is configured to perform the second exemplary scanning pattern 215 depicted in FIG. 2B, photodetector(s) 120 may be a single photodetector (e.g., no sub-pixelization) with dimensions that are less than or equal to the size of the beam spot emitted by laser source 106a. On the other hand, when LiDAR system 100 is configured to perform the third exemplary scanning pattern 230 depicted in FIG. 2C, photodetector(s) 120 may be a photodetector array that utilizes sub-pixelization. When sub-pixelization is utilized, the diameter of the beam spot emitted by first laser source 106a may be larger than when sub-pixelization is not used. Thus, the beam spot associated with the third exemplary scanning pattern 230 depicted in FIG. 2C may be larger than the beam spot associated with the second exemplary scanning pattern 215 depicted in FIG. 2B. One benefit of using a larger beam spot and/or sub-pixelization is that the MEMS frequency used to resonate the 1D MEMS scanning mirror during the scanning procedure may be lowered.

Referring to FIGS. 1 and 3A, second FOV 112b may be scanned using a 1D vertical flash and a 1D horizontal scanner. Here, second laser source 106b may emit second laser beam 107b as a flash. Rather than being a point of light, second laser beam 107b may have a vertical width of, e.g., 5°, which covers the entire vertical width of second FOV 112b. During, a second optical sensing procedure, second laser source 106b may emit a single flash pulse during each frame cycle to scan second FOV 112b. Then, the mechanical scanner (e.g., polygon scanner 130 in FIG. 1) steers the flash pulse so that it illuminates a different horizontal slice 302 (e.g., 0.1° in the horizontal direction) of second FOV 112b until the entire second FOV 112b is scanned. In the example depicted in FIG. 3A, the size of the horizontal slice 302 (and the flash pulse) illuminated by the flash pulse may be 5° in the vertical direction and 0.1° in the horizontal direction. In this embodiment, photodetector array(s) 120 may be a 2D detector array that has the same or smaller dimensions than second laser beam 107b. The 2D detector array may include sub-pixelization. In this example, second transmitter subsystem 150b may not include second scanner 108b or second scanning mirror 110b for the same or similar reasons as described above in connection with FIG. 2A.

Referring to FIGS. 1 and 3B, second FOV 112b may be scanned using 1D vertical MEMS scanner and a 1D horizontal scanner, in another embodiment consistent with the disclosure. Here, second laser source 106b may emit second laser beam 107b as a beam spot rather than a flash. In this example, second transmitter subsystem 150b may include second scanner 108b with a 1D MEMS scanning mirror (e.g., second scanning mirror 110b) that steers the beam spot to different vertical positions. In other words, the 1D MEMS scanning mirror may steer fourth laser beam 109b in a zig-zag pattern that moves down the vertical length of a first horizontal slice 302a each cycle until its vertical width has been scanned. In other words, the 1D MEMS scanning mirror may steer laser beam 109a in a zig-zag pattern that moves down the vertical length of a first horizontal slice 302a each cycle until its vertical width has been scanned. Then, the 1D horizontal scanner (e.g., mechanical scanner) steers the laser beam to the second horizontal slice 302b. At the beginning of the new cycle, the 1D MEMS scanning mirror steers fourth laser beam 109b back to the top of the second horizontal slice 302b before scanning down its vertical width. This scanning procedure is performed until the entire frame of second FOV 112b (e.g., which is the sum of all horizontal slices 302a, 302b . . . 302n) is scanned. Each horizontal slice is associated with one cycle. When LiDAR system 100 is configured to perform the fifth exemplary scanning pattern 315 depicted in FIG. 3B, photodetector(s) 120 may be a 1D horizontal photodetector array with, e.g., 10 pixels.

Referring to FIGS. 1 and 3C, second FOV 112b may be scanned using a 2D MEMS scanner. The 2D MEMS scanner may include a MEMS scanning mirror configured to steer fourth laser beam 109b in both the vertical and horizontal directions. Thus, in this embodiment, a mechanical scanner may not be used to scan the horizontal direction of second FOV 112b. Here, second laser source 106b may emit second laser beam 107b as a beam spot rather than a flash. In this example, second transmitter subsystem 150b may include second scanner 108b with a 2D MEMS scanning mirror (e.g., second scanning mirror 110b) that steers the beam spot (e.g., fourth laser beam 109b in FIG. 1) to different vertical and horizontal positions. In other words, the 2D MEMS scanning mirror may steer fourth laser beam 109b in a zig-zag pattern that moves across a vertical row of a first horizontal slice 302a until the entire horizontal length of that row has been scanned. Then, the 2D MEMS scanning mirror steers fourth laser beam 109b down to the vertical position of the next row in first horizontal slice 302a until first horizontal slice 302a has been scanned in its entirety. The 2D MEMS scanning mirror may then steer fourth laser beam 109b back to the top of the second horizontal slice 302b before scanning across each of those rows. This scanning procedure is performed until the entire frame of second FOV 112b (e.g., which is the sum of all horizontal slices 302a, 302b . . . 302n) is scanned. Each horizontal slice may be associated with one cycle. When LiDAR system 100 is configured to perform the sixth exemplary scanning pattern 330 depicted in FIG. 3C, photodetector(s) 120 may be a single photodetector that covers a portion of the vertical width and a portion of the horizontal width of second FOV 112b. For example, the single photodetector may cover 0.5° in the vertical direction and 0.1° in the horizontal direction.

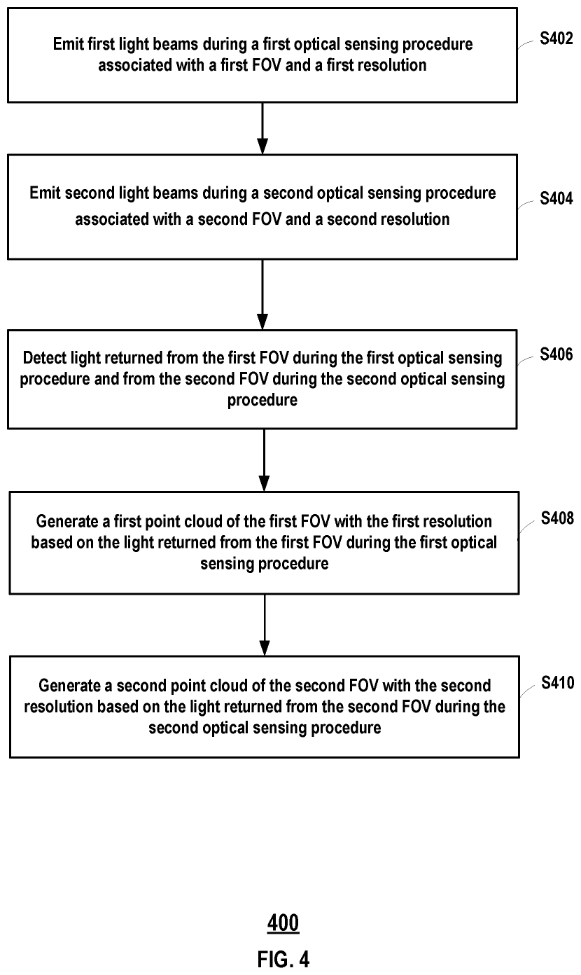

FIG. 4 illustrates a flowchart of an exemplary method 400 of operating a LiDAR system, according to embodiments of the disclosure. Method 400 may be performed by, e.g., LiDAR system 100 of FIG. 1. Method 400 may include steps S402-S410 as described below. It is to be appreciated that some of the steps may be optional, and some of the steps may be performed simultaneously, or in a different order than shown in FIG. 4.

Referring to FIG. 4, at S402, the LiDAR system may emit, by a first light source of a first transmitter subsystem, first light beams during a first optical sensing procedure associated with a first FOV and a first resolution. For example, referring to FIG. 1, first laser source 106a may be configured to emit a first laser beam 107a during a first optical sensing procedure performed by first transmitter subsystem 150a and receiver 104.

At S404, the LiDAR system may emit, by a second light source of a second transmitter subsystem, second light beams during a second optical sensing procedure associated with a second FOV and a second resolution finer than the first resolution. For example, referring to FIG. 1, second laser source 106b may be configured to emit a second laser beam 107b during a second optical sensing procedure performed by second transmitter subsystem 150b and receiver 104.

At S406, the LiDAR system may detect, by at least one photodetector, light returned from the first FOV during the first optical sensing procedure and from the second FOV during the second optical sensing procedure. For example, referring to FIG. 1, photodetector(s) 120 may include a single photodetector or photodetector array used for receiving laser beams returned from first FOV 112a and second FOV 112b. In some other embodiments, photodetector(s) 120 may include a first photodetector used for laser beams returned from first FOV 112a and a second photodetector used for receiving laser beams returned from second FOV 112b. The type(s) of photodetector(s) 120 included in LiDAR system 100 may depend on the implementation of first transmitter subsystem 150a and second transmitter subsystem 150b. For instance, when first transmitter subsystem 150a includes 1D vertical flash and a 1D horizontal scanner, photodetector(s) 120 may include a 1D vertical line with pixelization (see FIG. 2A). In another example, when first transmitter subsystem 150a includes a 1D MEMS scanner (e.g., vertical scanner) and 1D mechanical scanner (e.g., horizontal scanner), photodetector(s) 120 may be implemented as a single photodetector without sub-pixelization (see FIG. 2B) or a single photodetector with sub-pixelization (see FIG. 2C). When second transmitter subsystem 150b includes a 2D vertical flash and 1D horizontal scanner, photodetector(s) 120 may be implemented as a 2D photodetector array (see FIG. 3A). Still further, when second transmitter subsystem 150b is implemented using a 1D vertical MEMS scanner and a 1D horizontal scanner, photodetector(s) 120 may be implemented as a 1D horizontal line with pixelization (see FIG. 3B). In yet another example, when second transmitter subsystem 150b includes a 2D MEMS scanner, photodetector(s) 120 may be implemented as a single photodetector with or without sub-pixelization (see FIG. 3C).

At S408, the LiDAR system may generate, by a signal processor, a first point cloud of the first FOV with the first resolution based on the light returned from the first FOV during the first optical sensing procedure. For example, referring to FIG. 1, signal processor 124 may receive electrical signal 119 generated by photodetector(s) 120. Signal processor 124 may process electrical signal 119 to determine, for example, distance information carried by electrical signal 119. Signal processor 124 may construct a first point cloud based on the processed information associated with first FOV 112a/first returned laser beam 111a. The first point cloud may include a first frame, which is an image of the far-field located in first FOV 112a at a particular point in time. Signal processor 124 may include a microprocessor, a microcontroller, a central processing unit (CPU), a graphical processing unit (GPU), a digital signal processor (DSP), or other suitable data processing devices.

At S410, the LiDAR system may generate, by the signal processor, a second point cloud of the second FOV with the second resolution based on the light returned from the second FOV during the second optical sensing procedure. For example, referring to FIG. 1, signal processor 124 may receive electrical signal 119 generated by photodetector(s) 120. Signal processor 124 may process electrical signal 119 to determine, for example, distance information carried by electrical signal 119. Signal processor 124 may construct a second point cloud based on the processed information associated with second FOV 112b/second returned laser beam 111b. The second point cloud may include a second frame, which is an image of the far-field located in second FOV 112b at a particular point in time.

The exemplary LiDAR system 100 described above in connection with FIGS. 1-4 generates two FOVs of different sizes and resolutions. For example, LiDAR system 100 generates a first FOV that is large and has rough resolution and a second FOV that is smaller and has a finer resolution. For an area of importance, such as along the horizon where pedestrians, vehicles, or other objects may be located, the second FOV with the finer resolution may be used. Using fine resolution for the area of importance may achieve a higher-degree of accuracy/safety in terms of autonomous navigation decision-making than if coarse resolution is used. Because the use of fine resolution is limited to a relatively small area, a reasonably sized photodetector and laser power may still be used to generate a long distance, high-resolution point-cloud. For the region other than the second FOV, e.g., such as the peripheral regions away from the horizon, the first FOV with the rough resolution may be used.

It is intended that the specification and examples be considered as exemplary only, with a true scope being indicated by the following claims and their equivalents.

What is claimed is:

1. A light detection and ranging (LiDAR) system, comprising:
a first transmitter subsystem comprising:
a first light source configured to emit first light beams during a first optical sensing procedure associated with a first field-of-view (FOV) and a first resolution;
a second transmitter subsystem comprising:
a second light source configured to emit second light beams during a second optical sensing procedure associated with a second FOV and a second resolution finer than the first resolution;
at least one photodetector configured to detect light returned from the first FOV during the first optical sensing procedure and from the second FOV during the second optical sensing procedure; and
a signal processor coupled to the at least one photodetector and configured to:
generate a first point cloud of the first FOV with the first resolution based on the light returned from the first FOV during the first optical sensing procedure; and
generate a second point cloud of the second FOV with the second resolution based on the light returned from the second FOV during the second optical sensing procedure.

2. The LiDAR system of claim 1, further comprising:
a first scanner shared by the first transmitter subsystem and the second transmitter subsystem and configured to:
steer the first light beams in a first direction towards the first FOV; and
steer the second light beams in the first direction towards the second FOV, wherein the first scanner is a mechanical scanner.

3. The LiDAR system of claim 2, wherein:
the first transmitter subsystem comprises one of a first flash subsystem or a first micro-electrical-mechanical system (MEMS) subsystem, and
the second transmitter subsystem comprises one of a second flash subsystem or a second MEMS subsystem.

4. The LiDAR system of claim 3, wherein:
the first transmitter subsystem comprises a second scanner configured to steer the first light beams towards the first FOV in a second direction perpendicular to the first direction, and
the second transmitter subsystem comprises a third scanner configured to steer the second light beams towards the second FOV in the second direction,
wherein the first direction is associated with a horizontal scanning axis and the second direction is associated with a vertical scanning axis.

5. The LiDAR system of claim 4, wherein the first MEMS subsystem and the second MEMS subsystem each comprise a one-dimensional (1D) MEMS scanner or a two-dimensional (2D) MEMS scanner.

6. The LiDAR system of claim 3, wherein the first flash subsystem comprises a one-dimensional (1D) flash transmitter and the second flash subsystem comprises a two-dimensional (2D) flash transmitter.

7. The LiDAR system of claim 3, wherein the first MEMS subsystem comprises a one-dimensional (1D) MEMS transmitter and the second MEMS subsystem comprises a 1D MEMS transmitter or a two-dimensional (2D) MEMS transmitter.

8. The LiDAR system of claim 1, wherein the at least one photodetector comprises a one-dimensional (1D) detector array or a two-dimensional (2D) detector array.

9. The LiDAR system of claim 8, wherein the 1D detector array comprises sub-pixelization.

10. The LiDAR system of claim 1, wherein the first optical sensing procedure and the second optical sensing procedure are performed concurrently.

11. A transmitter for a light detection and ranging (LiDAR) system, comprising:
a first transmitter subsystem comprising:
a first light source configured to emit first light beams during a first optical sensing procedure associated with a first field-of-view (FOV) and a first resolution; and
a second transmitter subsystem comprising:
a second light source configured to emit second light beams during a second optical sensing procedure associated with a second FOV and a second resolution finer than the first resolution.

12. The transmitter of claim 11, further comprising:
a first scanner shared by the first transmitter subsystem and the second transmitter subsystem and configured to:
steer the first light beams in a first direction towards the first FOV; and
steer the second light beams in the first direction towards the second FOV, wherein the first scanner comprises a mechanical scanner.

13. The transmitter of claim 12, wherein:
the first transmitter subsystem comprises one of a first flash subsystem or a first micro-electrical-mechanical system (MEMS) subsystem, and
the second transmitter subsystem comprises one of a second flash subsystem or a second MEMS subsystem.

14. The transmitter of claim 13, wherein:
the first transmitter subsystem comprises a second scanner configured to steer the first light beams towards the first FOV in a second direction perpendicular to the first direction, and
the second transmitter subsystem comprises a third scanner configured to steer the second light beams towards the second FOV in the second direction,
wherein the first direction is associated with a horizontal scanning axis and the second direction is associated with a vertical scanning axis.

15. The transmitter of claim 13, wherein the first MEMS subsystem and the second MEMS subsystem each comprise a one-dimensional (1D) MEMS scanner or a two-dimensional (2D) MEMS scanner.

16. The transmitter of claim 11, wherein the first optical sensing procedure and the second optical sensing procedure are performed concurrently.

17. A method for operating a light detection and ranging (LiDAR) system, comprising:
emitting, by a first light source of a first transmitter subsystem, first light beams during a first optical sensing procedure associated with a first field-of-view (FOV) and a first resolution;
emitting, by a second light source of a second transmitter subsystem, second light beams during a second optical sensing procedure associated with a second FOV and a second resolution finer than the first resolution;
detecting, by at least one photodetector, light returned from the first FOV during the first optical sensing procedure and from the second FOV during the second optical sensing procedure;
generating, by a signal processor, a first point cloud of the first FOV with the first resolution based on the light returned from the first FOV during the first optical sensing procedure; and
generating, by the signal processor, a second point cloud of the second FOV with the second resolution based on the light returned from the second FOV during the second optical sensing procedure.

18. The method of claim 17, further comprising:
steering, by a first scanner, the first light beams in a first direction towards the first FOV; and
steering, by the first scanner, the second light beams in the first direction towards the second FOV,
wherein the first scanner comprises a mechanical scanner shared by the first transmitter subsystem and the second transmitter subsystem.

19. The method of claim 18, wherein:
the first transmitter subsystem comprises one of a first flash subsystem or a first micro-electrical-mechanical (MEMS) subsystem, and
the second transmitter subsystem comprises one of a second flash subsystem or a second MEMS subsystem.

20. The method of claim 19, further comprising:
steering, by the first MEMS subsystem, the first light beams towards the first FOV in a second direction perpendicular to the first direction, and
steering, by the second MEMS subsystem, the second light beams towards the second FOV in the second direction,
wherein the first direction is associated with a horizontal scanning axis and the second direction is associated with a vertical scanning axis.
